(19) United States
(12) Patent Application Publication
(10) Pub. No.: US 2019/0246668 A1
(43) Pub. Date: Aug. 15, 2019

(54) Low-Sugar Carbonated Beverage

(71) Applicant: Luma Soda, Inc., Mountain View, CA (US)

(72) Inventors: James C. Otteson, Palo Alto, CA (US); Samson Hsia, Fremont, CA (US)

(21) Appl. No.: 16/263,483

(22) Filed: Jan. 31, 2019

Related U.S. Application Data
(60) Provisional application No. 62/625,720, filed on Feb. 2, 2018.

(51) Int. Cl. A23L 2/60; A23L 2/56; A23L 29/30; A23L 2/54

(52) U.S. Cl. CPC A23L 2/60; A23L 2/56; A23L 2/58; A23L 2/54; A23L 29/30

(57) ABSTRACT

Low-sugar carbonated beverages are disclosed herein. The beverages can include carbonated water, monk fruit product, and a caloric sweetener, such as sucrose or honey. The beverages can be disposed within a suitable container, such as containers traditionally used for soft drinks. In some circumstances, the beverage within the container may be pasteurized to ensure safety.

### CROSS REFERENCE

This application claims the benefit of U.S. Provisional Application No. 62/625,720, filed Feb. 2, 2018 and titled “LOW-SUGAR CARBONATED BEVERAGE,” which is hereby incorporated by reference in its entirety.

### BACKGROUND

A typical twelve-ounce can of soda can contain anywhere from 30 to 50 grams of sugar.

Thus, consumption of single can of soda often results in intake of more than the maximum recommended daily amount for added sugars. Such high-sugar/high-calorie sodas contribute to numerous health problems, such as obesity, type 2 diabetes, and heart disease.

Many zero- or low-calorie sodas are poor substitutes for sugar- and calorie-rich sodas. Such sodas often contain chemically synthesized artificial sweeteners that may themselves be detrimental to human health. For instance, concern has been expressed that various artificial sweeteners contribute to weight gain, obesity, heart disease, and metabolic syndrome. Such zero- or low-calorie sodas also often have an undesired aftertaste and/or a suboptimal mouthfeel. Accordingly, many zero- or low-calorie sodas are judged as deficient in one or more properties upon organoleptic evaluation. Thus, there is a need for low-calorie sodas that lack various sweeteners (e.g., artificial sweeteners) and/or have improved mouthfeel.

Furthermore, both low-calorie and high-calorie sodas often include other undesired chemical compounds (e.g., inorganic acids such as phosphoric acid, artificial preservatives, caramel color) that may be carcinogenic or have other potentially harmful side effects. There is market demand for low-sugar sodas that avoid such undesired chemicals.

### SUMMARY OF THE INVENTION

An aspect of the disclosure provides methods and compositions of beverages. A beverage may comprise carbonated water; a monk fruit product; and a caloric sweetener that is not from the monk fruit product. The beverage may have between 15 and 35 calories per 12 fluid ounces.

In some embodiments, a beverage comprises citric acid. In some embodiments, the beverage may comprise one or more natural flavors. In some embodiments, the beverage comprises a color additive. In some embodiments, the monk fruit product comprises one or both of monk fruit juice concentrate or monk fruit extract.

In some embodiments, the beverage may be substantially devoid of all of the following preservatives: sodium benzoate, potassium benzoate, calcium benzoate, erythorbic acid, calcium erythorbate, sodium erythorbate, butylated hydroxyanisole, butylated hydroxytoluene, phosphoric acid, sodium sorbate, potassium sorbate, sodium polyphosphate, potassium polyphosphate, sodium hexametaphosphate, tetrasodium pyrophosphate, propyl-p-hydroxy-benzoate, and methyl-p-hydroxy-benzoate (methylparaben), and EDTA.

In some embodiments, the beverage may be a pasteurized beverage. In some embodiments, the beverage may have a pH of between 2.2 and 5.0. In some embodiments, the beverage may be substantially devoid of any artificial sweetener.

In some embodiments, the beverage may be substantially devoid of all of the following sweeteners: acesulfame potassium, advantame, alitame, aspartame, cyclamate, dulcin, glucin, neohesperidin dihydrochalcone, neotame, P-4000, saccharin, aspartame-acesulfame salt, sucralose, brazzein, curculin, glycyrrhizin, glycerol, inulin, mabinlin, malto-oligosaccharide, mannitol, erythritol, xylitol, sorbitol, malitol, isomalt, lactitol, hydrogenated starch hydrolysates, miraculin, monatin, monellin, osladin, pentadin, stevia, trilobatin, and thaumatin

In some embodiments, the caloric sweetener may comprise or consist of one or more of honey and sucrose. In some embodiments, the beverage may be substantially devoid of artificial colors. In some embodiments, the beverage may be substantially devoid of artificial flavors. In some embodiments, the caloric sweetener may comprise sucrose or honey. In some cases, the sucrose or honey may be present in the beverage at a concentration of between 1 and 3 grams of sucrose or honey per twelve fluid ounces of beverage.

In some embodiments, the beverage may comprise between 0.02% and 0.07% mogroside V by weight. In some embodiments, the beverage may be, by weight: between 94% and 99% carbonated water; between 0.02% and 0.07% mogroside V; and between 0.3% and 0.7% caloric sweetener that is not from the monk fruit product.

In some aspects, the beverage may be filled in a sealed container. In some embodiments, the sealed container may be capable of withstanding an internal pressure of no more than 90, 100, 110, or 120 psi. In some embodiments, the sealed container may comprise aluminum. In some embodiments, at least 2.0, 2.2, 2.5, 2.6, 2.7, 2.8. 2.9, 3.0, 3.1, 3.2, 3.3, 3.4, 3.5, 3.6, 3.7, 3.8, or 4.0 volumes of CO₂ may be dissolved in the beverage.

In some aspects, methods of producing beverages are disclosed. In some methods, methods for producing a sealed beverage product may comprise obtaining the sealed container and pasteurizing the beverage while the beverage is within the sealed container. In some embodiments, the method may comprise heating the beverage within the container to a temperature of at least 145° F.

### DETAILED DESCRIPTION

Carbonated beverages, related compositions, and methods of producing and/or processing carbonated beverages are disclosed herein. Beverages or other mixtures described herein may include one more compositions or ingredients. For instance, in some embodiments, a beverage may include, among other things, (1) carbonated water, (2) a monk fruit product, and (3) a caloric sweetener.

As noted above, beverages disclosed herein may include carbonated water. The water may be carbonated by any suitable method. In some embodiments, the carbonated water may be filtered water (e.g., water that has been filtered prior to carbonation). In some instances, the water is carbonated prior to its mixture with one or more other ingredients (such as a syrup that includes one or all of the remaining ingredients of the beverage, such as monk fruit product). In other instances, carbonation of the water may be performed after the water has been mixed with one or more other ingredients (e.g., a syrup that includes monk fruit product) of the beverage.

In some embodiments, the beverage is from 94.0% to 99.0% water by weight. For example, in some embodiments, the beverage is at least 94.0% water by weight. In some embodiments, the beverage is no more than 99.0% water by weight. In some embodiments, the beverage is from 94.0% to 95.0% water by weight, from 94.0% to 96.0% water by weight, from 94.0% to 97.0% water by weight, from 94.0% to 98.0% water by weight, from 94.0% to 99.0% water by weight, from 95.0% to 96.0% water by weight, from 95.0% to 97.0% water by weight, from 95.0% to 98.0% water by weight, from 95.0% to 99.0% water by weight, from 96.0% to 97.0% water by weight, from 96.0% to 98.0% water by weight, from 96.5% to 98.0% by weight; from 96.0% to 99.0% water by weight, from 97.0% to 98.0% water by weight, from 97.0% to 99.0% water by weight, or from 98.0% to 99.0% water by weight. In some embodiments, the beverage may be about 94.0%, about 95.0%, about 96.0%, about 97.0%, about 98.0%, or about 99.0% water by weight. (Unless otherwise stated, all ranges include both endpoints and all numbers between the endpoints.)

The concentration of carbon dioxide (CO₂) dissolved in the beverages is usually defined either in terms of “volumes” or “g/L.” The first approach defines the number of volumes of CO₂ (under standard conditions of 0° C. and 1 atm) that are dissolved in each volume of the liquid. The second approach indicates the grams of CO₂ that are dissolved in each liter of liquid. One volume of carbonation is approximately equal to 2 g/L.

In some embodiments, the concentration of CO₂ in the beverage is from 2.0 volumes to 4.0 volumes. For instance, in some embodiments, the concentration of CO₂ dissolved in the beverage is at least 2.0 volumes. In some embodiments, the concentration of CO₂ dissolved in the beverage is at most 4.0 volumes. In some embodiments, the concentration of CO₂ dissolved in the beverage may be from 2.0 to 2.2, from 2.0 to 2.5, from 2.0 to 2.7, from 2.0 to 2.9, from 2.0 to 3.0, from 2.0 to 3.2, from 2.0 to 3.5, from 2.0 to 3.7, from 2.0 to 4.0, from 2.2 to 2.5, from 2.2 to 2.7, from 2.2 to 2.9, from 2.2 to 3.0, from 2.2 to 3.2, from 2.2 to 3.5, from 2.2 to 3.7, from 2.2 to 4.0, from 2.5 to 2.7, from 2.5 to 2.9, from 2.5 to 3.0, from 2.5 to 3.2, from 2.5 to 3.5, from 2.5 to 3.7, from 2.5 to 4.0, from 2.7 to 2.9, from 2.7 to 3.0, from 2.7 to 3.2, from 2.7 to 3.5, from 2.7 to from 3.7, 2.7 to from 4.0, from 2.9 to 3.0, from 2.9 to 3.2, from 2.9 to 3.5, from 2.9 to 3.7, from 2.9 to 4.0, from 3.0 to 3.2, from 3.0 to 3.5, from 3.0 to 3.7, from 3.0 to 4.0, from 3.2 to 3.5, from 3.2 to 3.7, from 3.2 to 4.0, from 3.5 to 3.7, from 3.5 to 4.0, or from 3.7 to 4.0. In some embodiments, the concentration of CO₂ dissolved in the beverage may be about 2.0, 2.2, 2.5, 2.7, 2.9, 3.0, 3.2, 3.5, 3.7, or 4.0 volumes.

Beverages disclosed herein may include one or more monk fruit products. Monk fruit, or luo han guo, is a fruit from Siraitia grosvenorii, a plant native to southern China and northern Thailand. Monk fruit is notable for its sweetness, and includes a plurality of natural sweeteners. Monk fruit products include, inter alia, monk fruit juice, monk fruit juice extract, monk fruit juice concentrate, and monk fruit juice concentrate powder. Monk fruit products may be used to sweeten beverages described herein. In addition to sweetness, monk fruit products may have one or more other properties, such as antioxidant properties, anti-inflammatory properties, anti-tumor properties.

In some embodiments, the concentration of monk fruit product (e.g., monk fruit juice extract, monk fruit juice concentrate, or monk fruit juice concentrate in crystalline form) in a beverage is from 0.01% to 2.5% by weight. For instance, in some embodiments, the concentration of monk fruit product in a beverage may be at least 0.01% by weight. In some embodiments, the concentration of monk fruit product in a beverage may be no more than 2.5% by weight. In some embodiments, the concentration of monk fruit product in a beverage is from 0.01% to 0.05% by weight, 0.01% to 0.20% by weight, 0.01% to 0.50% by weight, 0.01% to 0.70% by weight, 0.01% to 1.0% by weight, 0.01% to 1.2% by weight, 0.01% to 1.5% by weight, 0.01% to 1.7% by weight, 0.01% to 2.0% by weight, 0.01% to 2.2% by weight, 0.01% to 2.5% by weight, 0.05% to 0.20% by weight, 0.05% to 0.50% by weight, 0.05% to 0.7% by weight, 0.05% to 1.0% by weight, 0.05% to 1.2% by weight, 0.05% to 1.5% by weight, 0.05% to 1.7% by weight, 0.05% to 2.0% by weight, 0.05% to 2.2% by weight, 0.05% to 2.5% by weight, 0.20% to 0.50% by weight, 0.20% to 0.70% by weight, 0.20% to 1.0% by weight, 0.20% to 1.2% by weight, 0.20% to 1.5% by weight, 0.20% to 1.7% by weight, 0.20% to 2.0% by weight, 0.20% to 2.2% by weight, 0.20% to 2.5% by weight, 0.50% to 0.70% by weight, 0.50% to 1.0% by weight, 0.50% to 1.2% by weight, 0.50% to 1.5% by weight, 0.50% to 1.7% by weight, 0.50% to 2.0% by weight, 0.50% to 2.2% by weight, 0.50% to 2.5% by weight, 0.70% to 1.0% by weight, 0.70% to 1.2% by weight, 0.70% to 1.5% by weight, 0.70% to 1.7% by weight, 0.70% to 2.0% by weight, 0.70% to 2.2% by weight, 0.70% to 2.5% by weight, 1.0% to 1.2% by weight, 1.0% to 1.5% by weight, 1.0% to 1.7% by weight, 1.0% to 2.0% by weight, 1.0% to 2.2% by weight, 1.0% to 2.5% by weight, 1.2% to 1.5% by weight, 1.2% to 1.7% by weight, 1.2% to 2.0% by weight, 1.2% to 2.2% by weight, 1.2% to 2.5% by weight, 1.5% to 1.7% by weight, 1.5% to 2.0% by weight, 1.5% to 2.2% by weight, 1.5% to 2.5% by weight, 1.7% to 2.0% by weight, 1.7% to 2.2% by weight, 1.7% to 2.5% by weight, 2.0% to 2.2% by weight, 2.0% to 2.5% by weight, or 2.2% to 2.5% by weight. In some embodiments, the concentration of monk fruit product in a beverage is about 0.01%, about 0.05%, about 0.20%, about 0.50%, about 0.70%, about 1.0%, about 1.2%, about 1.5%, about 1.7%, about 2%, about 2.2%, or about 2.5% by weight.

In some embodiments, monk fruit products include one or more natural sweetener compounds. For instance, in some embodiments, monk fruit products include one or more low-calorie sweetener compounds. The term “low-calorie sweetener compound” refers to compounds that have less than 10% of the calories of an equal weight of sucrose. In some embodiments, a low calorie sweetener compound has less than 5%, less than 3%, less than 2%, and/or less than 1% of the calories of an equal weight of sucrose.

In some embodiments, the one or more natural low-calorie sweetener compounds from monk fruit products include one or more saponins, such as one or more mogrosides. In particular, in some embodiments, the monk fruit product includes mogroside V. In some embodiments, the one or more low-calorie sweetener compounds (e.g., mogroside V) may have one or more other properties, such as antioxidant properties, anti-inflammatory properties, anti-tumor properties, and/or improved mouthfeel relative to various artificial low-calorie sweetener compounds. In some embodiments, monk fruit product is present in the beverage such that the concentration of mogroside V in the beverage is between 0.01% and 0.09% of the beverage by weight. For example, in some embodiments, the beverage is between about 0.20% and 0.08%, 0.30% and 0.07%, and/or 0.04% and 0.05% mogroside V by weight.

In some embodiments, in addition to low-calorie sweeteners, the monk fruit product further includes one of more caloric (i.e., non-low calorie) natural sweetener compounds, such as glucose and/or fructose. In some embodiments, the contribution of calories in the beverage that are from caloric natural sweetener compounds from the monk fruit product is less than 18, less than 16, less than 15, or less than 14 calories per 12 fluid ounces.

Beverages disclosed herein may, in some instances, further include one or more caloric sweeteners (such as one or more natural caloric sweeteners) that are not derived from monk fruit product. Examples of caloric sweeteners include—but are not limited to—honey, cane sugar (sucrose), and agave nectar. Honey used in the beverages may be comb honey, liquid honey, granulated honey, creamed honey, chunk honey, or combinations thereof. The honey may be raw or pasteurized. In some embodiments, the beverage is between 0.2% to 1.5% (e.g., 0.2% to 1.0%) caloric sweetener by weight. In some embodiments, the beverage is at least 0.2% caloric sweetener by weight. In some embodiments, the beverage is not more than 1.5% (e.g., not more than 1.0%) caloric sweetener by weight. In some embodiments, the beverage is between 0.2% and 0.4%, between 0.3% and 0.5%, between 0.4% and 0.6%, between 0.5% and 0.7%, between 0.6% and 0.8%, between 0.7% and 0.9%, between 0.8% and 1.0%, between 0.9% and 1.1%, between 1.0% and 1.2%, between 1.1% and 1.3%, between 1.2% and 1.4%, between 1.3% and 1.5%, between 0.2% and 0.5%, between 0.3% and 0.6%, between 0.4% and 0.7%, between 0.5% and 0.8%, between 0.6% and 0.9%, between 0.7% and 1.0%, between 0.8% and 1.1% between 0.9% and 1.2%, between 1.0% and 1.3%, between 1.1% and 1.4%, or between 1.2% and 1.5% caloric sweetener by weight. The inclusion of caloric sweeteners, such as natural caloric sweeteners, may improve the mouthfeel and/or other organoleptic characteristics of the beverage relevant to analogous beverages in which such caloric sweeteners have not been added. In some embodiments, caloric sweeteners from sources other than monk fruit product are present at a concentration of between 1 and 4 grams, between 1 and 3 grams, between 1 and 2 grams, between 2 and 3 grams, between 2 and 4 grams, or between 3 and 4 grams of caloric sweetener per 12 fluid ounces of beverage. For example, in some embodiments, beverages include between 1 and 4 grams, between 1 and 3 grams, between 1 and 2 grams, between 2 and 3 grams, between 2 and 4 grams, or between 3 and 4 grams of honey or sucrose per 12 fluid ounces of beverage.

In some embodiments, beverages disclosed herein include one or more natural flavors (other than the flavors included in the monk fruit extract). The terms “natural flavor” or “natural flavoring” can refer, for example, to the essential oil, oleoresin, essence or extractive, protein hydrolysate, distillate, or any product of, for example, roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional. A wide variety of natural flavorings are available and include, but are not limited to, cola (kola nuts), cherry, tangerine, orange, grape, blood orange, berry (strawberry, raspberry, blueberry, blackberry, etc.), lemon, lime, ginger, vanilla, cocoa, mint, basil, and any combinations thereof.

In some embodiments, the concentration of natural flavoring (or combinations of natural flavoring) in the beverage that are not derived from monk fruit is from 0.1% to 1.5% by weight. For instance, the concentration of natural flavoring (or combinations of natural flavoring) in a beverage may be at least 0.1% by weight. In some embodiments, the concentration of natural flavoring (or combinations of natural flavoring) in a beverage may be no more than 1.5% by weight. In some embodiments, the concentration of natural flavoring (or combinations of natural flavoring) in the beverages may be from 0.1% by weight to 0.2% by weight, 0.1% by weight to 0.5% by weight, 0.1% by weight to 0.7% by weight, 0.1% by weight to 1.0% by weight, 0.1% by weight to 1.2% by weight, 0.1% by weight to 1.5% by weight, 0.2% by weight to 0.5% by weight, 0.2% by weight to 0.7% by weight, 0.2% by weight to 1.0% by weight, 0.2% by weight to 1.2% by weight, 0.2% by weight to 1.5% by weight, 0.5% by weight to 0.7% by weight, 0.5% by weight to 1.0% by weight, 0.5% by weight to 1.2% by weight, 0.5% by weight to 1.5% by weight, 0.7% by weight to 1.0% by weight, 0.7% by weight to 1.2% by weight, 0.7% by weight to 1.5% by weight, 1.0% by weight to 1.2% by weight, 1.0% by weight to 1.5% by weight, or 1.2% by weight to 1.5% by weight. In some embodiments, the concentration of natural flavoring (or combinations of natural flavoring) in the beverages may be 0.1% by weight, 0.2% by weight, 0.5% by weight, 0.7% by weight, 1.0% by weight, 1.2% by weight, or 1.5% by weight.

In some embodiments, a beverage includes one or more acidic compounds, such as natural acidic compounds that provide flavor. Such natural acidic compounds may function as pH modulators. Examples of natural acidic compounds that provide flavor include, but are not limited to, citric acid, ascorbic acid, and malic acid. Acidic compounds may be from organic sources, non-genetically modified organism (non-GMO) sources, or GMO sources. In some cases, a beverage is less than 2.00%, less than 1.80%, less than 1.70%, less than 1.60%, less than 1.50%, less than 1.40%, less than 1.20%, less than 1.10%, less than 1.00%, less than 0.50%, less than 0.20%, less than 0.10% or less than 0.05% by weight of acidic compounds, such as natural citric acid. In some cases, the concentration of the one or more acidic compounds (e.g., citric acid) may be from 0.05% by weight to 2.00% by weight. In some cases, the concentration of the one or more acidic compounds (e.g., citric acid) may be at least 0.05% by weight. In some cases, the concentration of the one or more acidic compounds (e.g., citric acid) may be at most 2.00% by weight. In some cases, the concentration of the one or more acidic compounds (e.g., citric acid) may be 0.05% by weight to 0.10% by weight, 0.05% by weight to 0.50% by weight, 0.05% by weight to 1.00% by weight, 0.05% by weight to 1.50% by weight, 0.05% by weight to 2.00% by weight, 0.10% by weight to 0.50% by weight, 0.10% by weight to 1.00% by weight, 0.10% by weight to 1.50% by weight, 0.10% by weight to 2.00% by weight, 0.50% by weight to 1.00% by weight, 0.50% by weight to 1.50% by weight, 0.50% by weight to 2.00% by weight, 1.00% by weight to 1.50% by weight, 1.00% by weight to 2.00% by weight, or 1.50% by weight to 2.00% by weight. In some cases, the concentration of the one or more acidic compounds (e.g., citric acid) may be about 0.05% by weight, about 0.10% by weight, about 0.50% by weight, about 1.00% by weight, about 1.50% by weight, or about 2.00% by weight.

Some beverages may include one or more color additives that function to alter the color of the beverage. In some embodiments, the one or more color additive(s) are natural color additives or color additives that are exempt from certification under 21 C.F.R. § 73. In some beverages, no natural color additive is included. In some embodiments, a natural color additive, such as a vegetable or fruit juice, may be used to alter the color of the beverage. In some embodiments, the concentration of color additives in the beverage is from 0.0 to 0.7% by weight. In some embodiments, the concentration of natural color additives in the beverage is at most 0.7% by weight. In some embodiments, the concentration of natural color additives in the beverage is from 0.0% by weight to 0.1% by weight, 0.0% by weight to 0.2% by weight, 0.0% by weight to 0.3% by weight, 0.0% by weight to 0.4% by weight, 0.0% by weight to 0.5% by weight, 0.0% by weight to 0.6% by weight, 0.0% by weight to 0.7% by weight, 0.1% by weight to 0.2% by weight, 0.1% by weight to 0.3% by weight, 0.1% by weight to 0.4% by weight, 0.1% by weight to 0.5% by weight, 0.1% by weight to 0.6% by weight, 0.1% by weight to 0.7% by weight, 0.2% by weight to 0.3% by weight, 0.2% by weight to 0.4% by weight, 0.2% by weight to 0.5% by weight, 0.2% by weight to 0.6% by weight, 0.2% by weight to 0.7% by weight, 0.3% by weight to 0.4% by weight, 0.3% by weight to 0.5% by weight, 0.3% by weight to 0.6% by weight, 0.3% by weight to 0.7% by weight, 0.4% by weight to 0.5% by weight, 0.4% by weight to 0.6% by weight, 0.4% by weight to 0.7% by weight, 0.5% by weight to 0.6% by weight, 0.5% by weight to 0.7% by weight, or 0.6% by weight to 0.7% by weight. In some embodiments, the concentration of natural color additives in the beverage is approximately 0.0% by weight, 0.1% by weight, 0.2% by weight, 0.3% by weight, 0.4% by weight, 0.5% by weight, 0.6% by weight, or 0.7% by weight. Some beverages are devoid (or substantially devoid) of artificial colors.

In some embodiments, the calorie density of the beverages described herein is from 0.8 calories per fluid ounce to 4.5 calories per fluid ounce. In some embodiments, the calorie density of the beverages may be at least 0.8 calories per fluid ounce. In some embodiments, the calorie density of the beverage may be at most 4.5 calories per fluid ounce. In some embodiments, the calorie density of the beverage may be 0.8 calories per fluid ounce to 1.0 calorie per fluid ounce, 0.8 calories per fluid ounce to 1.5 calories per fluid ounce, 0.8 calories per fluid ounce to 2.0 calories per fluid ounce, 0.8 calories per fluid ounce to 2.5 calories per fluid ounce, 0.8 calories per fluid ounce to 3.0 calories per fluid ounce, 0.8 calories per fluid ounce to 3.5 calories per fluid ounce, 0.8 calories per fluid ounce to 4 calories per fluid ounce, 0.8 calories per fluid ounce to 4.5 calories per fluid ounce, 1.0 calorie per fluid ounce to 1.5 calories per fluid ounce, 1.0 calorie per fluid ounce to 2.0 calories per fluid ounce, 1.0 calorie per fluid ounce to 2.5 calories per fluid ounce, 1.0 calorie per fluid ounce to 3.0 calories per fluid ounce, 1.0 calorie per fluid ounce to 3.5 calories per fluid ounce, 1.0 calorie per fluid ounce to 4.0 calories per fluid ounce, 1.0 calorie per fluid ounce to 4.5 calories per fluid ounce, 1.5 calories per fluid ounce to 2 calories per fluid ounce, 1.5 calories per fluid ounce to 2.5 calories per fluid ounce, 1.5 calories per fluid ounce to 3.0 calories per fluid ounce, 1.5 calories per fluid ounce to 3.5 calories per fluid ounce, 1.5 calories per fluid ounce to 4.0 calories per fluid ounce, 1.5 calories per fluid ounce to 4.5 calories per fluid ounce, 2.0 calories per fluid ounce to 2.5 calories per fluid ounce, 2.0 calories per fluid ounce to 3.0 calories per fluid ounce, 2.0 calories per fluid ounce to 3.5 calories per fluid ounce, 2.0 calories per fluid ounce to 4.0 calories per fluid ounce, 2.0 calories per fluid ounce to 4.5 calories per fluid ounce, 2.5 calories per fluid ounce to 3.0 calories per fluid ounce, 2.5 calories per fluid ounce to 3.5 calories per fluid ounce, 2.5 calories per fluid ounce to 4.0 calories per fluid ounce, 2.5 calories per fluid ounce to 4.5 calories per fluid ounce, 3.0 calories per fluid ounce to 3.5 calories per fluid ounce, 3.0 calories per fluid ounce to 4.0 calories per fluid ounce, 3.0 calories per fluid ounce to 4.5 calories per fluid ounce, 3.5 calories per fluid ounce to 4.0 calories per fluid ounce, 3.5 calories per fluid ounce to 4.5 calories per fluid ounce, or 4.0 calories per fluid ounce to 4.5 calories per fluid ounce. In some embodiments, the caloric count of the beverages may be about 0.8 calories per fluid ounce, about 1.0 calorie per fluid ounce, about 1.5 calories per fluid ounce, about 2.0 calories per fluid ounce, about 2.5 calories per fluid ounce, about 3.0 calories per fluid ounce, about 3.5 calories per fluid ounce, about 4.0 calories per fluid ounce, or about 4.5 calories per fluid ounce. In some embodiments, the beverage has between 10 and 50 (e.g., between 15 and 35 or between 20 and 30) calories per 12 fluid ounces.

In some embodiments, beverages disclosed herein may be devoid (or substantially devoid) of artificial flavoring. The terms “artificial flavor” or “artificial flavoring” mean any substance, the function of which is to impart flavor, which is not derived from a spice, fruit or fruit juice, vegetable or vegetable juice, edible yeast, herb, bark, bud, root, leaf or similar plant material, meat, fish, poultry, eggs, dairy products, or fermentation products thereof. Artificial flavor includes the substances listed in 21 C.F.R. 172.515(b) and 21 C.F.R. § 582.60 except where these are derived from natural sources. In some cases, the beverages include artificial flavoring at concentrations of less than 0.100% by weight, less than 0.050% by weight, less than 0.010% by weight, less than 0.005% by weight or less than 0.001% by weight.

In some embodiments, the pH of the beverages is from 2.2 to 5.0. In some embodiments, the pH of the beverage is at least 2.2. In some embodiments, the pH of the beverage is at most 5.0. In some embodiments, the pH of the beverage is from 2.2 to 2.5, from 2.2 to 3, from 2.2 to 3.5, from 2.2 to 4.0, from 2.2 to 4.5, from 2.2 to 5.0, from 2.5 to 3.0, from 2.5 to 3.5, from 2.5 to 4.0, from 2.5 to 4.5, from 2.5 to 5.0, from 3.0 to 3.5, from 3.0 to 4.0, from 3.0 to 4.5, from 3.0 to 5.0, from 3.5 to 4.0, from 3.5 to 4.5, from 3.5 to 5.0, from 4.0 to 4.5, from 4.0 to 5.0, or from 4.5 to 5.0.

In some embodiments, the beverages are devoid (or substantially devoid) of artificial sweeteners. In some embodiments, the beverage is substantially devoid of all of the following sugar substitutes: acesulfame potassium, advantame, alitame, aspartame, sodium cyclamate, dulcin, glucin, neohesperidin dihydrochalcone, neotame, P-4000, saccharin, aspartame-acesulfame salt, sucralose, brazzein, curculin, glycyrrhizin, glycerol, inulin, mabinlin, malto-oligosaccharide, mannitol, erythritol, xylitol, sorbitol, malitol, isomalt, lactitol, hydrogenated starch hydrolysates, miraculin, monatin, monellin, osladin, pentadin, stevia (including partly stevia components), trilobatin, and thaumatin. In some cases, the beverages may have less than 2.00% by weight, less than 1.80% by weight, less than 1.70% by weight, less than 1.50% by weight, less than 1.20% by weight, less than 1.00% by weight, less than 0.50% by weight, less than 0.20% by weight, less than 0.10% by weight or less than 0.05% by weight of the sugar substitutes or artificial sweeteners.

In some embodiments, the beverages may be substantially devoid of common chemical preservatives. For example, in some embodiments, a beverage may be substantially devoid of each of the following preservatives: sodium benzoate, potassium benzoate, calcium benzoate, erythorbic acid, calcium erythorbate, sodium erythorbate, butylated hydroxyanisole, butylated hydroxytoluene, phosphoric acid, sodium sorbate, potassium sorbate, sodium polyphosphate, potassium polyphosphate, sodium hexamentaphosphate, tetrasodium pyrophosphate, propyl-p-hydroxy-benzoate, and methyl-p-hydroxy-benzoate (methylparaben), and chelators such as EDTA. In some cases, the beverages are less than 0.100% by weight, less than 0.050% by weight, less than 0.010% by weight, less than 0.005% by weight or less than 0.001% by weight of chemical preservatives.

Beverages disclosed herein may be disposed within a sealed container (e.g., a metal can, glass bottle, or plastic bottle), such as containers typically used for carbonated beverages like soda, beer, etc. The capacity of the container may be any suitable amount, such as between 6 fluid ounces to 24 fluid ounces. In some embodiments, the capacity of the container is at least 6 fluid ounces. In some embodiments, the capacity of the container is at most 24 fluid ounces. In some embodiments, the capacity of the container may be 6 fluid ounces to 8 fluid ounces, 6 fluid ounces to 10 fluid ounces, 6 fluid ounces to 12 fluid ounces, 6 fluid ounces to 14 fluid ounces, 6 fluid ounces to 16 fluid ounces, 6 fluid ounces to 18 fluid ounces, 6 fluid ounces to 20 fluid ounces, 6 fluid ounces to 22 fluid ounces, 6 fluid ounces to 24 fluid ounces, 8 fluid ounces to 10 fluid ounces, 8 fluid ounces to 12 fluid ounces, 8 fluid ounces to 14 fluid ounces, 8 fluid ounces to 16 fluid ounces, 8 fluid ounces to 18 fluid ounces, 8 fluid ounces to 20 fluid ounces, 8 fluid ounces to 22 fluid ounces, 8 fluid ounces to 24 fluid ounces, 10 fluid ounces to 12 fluid ounces, 10 fluid ounces to 14 fluid ounces, 10 fluid ounces to 16 fluid ounces, 10 fluid ounces to 18 fluid ounces, 10 fluid ounces to 20 fluid ounces, 10 fluid ounces to 22 fluid ounces, 10 fluid ounces to 24 fluid ounces, 12 fluid ounces to 14 fluid ounces, 12 fluid ounces to 16 fluid ounces, 12 fluid ounces to 18 fluid ounces, 12 fluid ounces to 20 fluid ounces, 12 fluid ounces to 22 fluid ounces, 12 fluid ounces to 24 fluid ounces, 14 fluid ounces to 16 fluid ounces, 14 fluid ounces to 18 fluid ounces, 14 fluid ounces to 20 fluid ounces, 14 fluid ounces to 22 fluid ounces, 14 fluid ounces to 24 fluid ounces, 16 fluid ounces to 18 fluid ounces, 16 fluid ounces to 20 fluid ounces, 16 fluid ounces to 22 fluid ounces, 16 fluid ounces to 24 fluid ounces, 18 fluid ounces to 20 fluid ounces, 18 fluid ounces to 22 fluid ounces, 18 fluid ounces to 24 fluid ounces, 20 fluid ounces to 22 fluid ounces, 20 fluid ounces to 24 fluid ounces, or 22 fluid ounces to 24 fluid ounces. In some embodiments, the capacity of the container may be 6 fluid ounces, 8 fluid ounces, 10 fluid ounces, 12 fluid ounces, 14 fluid ounces, 16 fluid ounces, 18 fluid ounces, 20 fluid ounces, 22 fluid ounces, or 24 fluid ounces. In some embodiments, the container is a traditional 12 fluid ounce container as is commonly used for packaging carbonated beverages.

In some embodiments, the container comprises one or more of aluminum, manganese, magnesium, chromium, iron, silicon and copper. In some embodiments, the container may be primarily composed of aluminum. For instance, in some embodiments, the container may be about 94% to 99% aluminum by weight.

In some embodiments, the concentration of aluminum in a container may be 94% by weight to 99% by weight. In some embodiments, the concentration of aluminum in a container may be at least 94% by weight. In some embodiments, the concentration of aluminum in a container may be at most 99% by weight. In some embodiments, the concentration of aluminum in a container may be 94% by weight to 95% by weight, 94% by weight to 96% by weight, 94% by weight to 97% by weight, 94% by weight to 98% by weight, 94% by weight to 99% by weight, 95% by weight to 96% by weight, 95% by weight to 97% by weight, 95% by weight to 98% by weight, 95% by weight to 99% by weight, 96% by weight to 97% by weight, 96% by weight to 98% by weight, 96% by weight to 99% by weight, 97% by weight to 98% by weight, 97% by weight to 99% by weight, or 98% by weight to 99% by weight.

In some embodiments, the container may include manganese. In some embodiments, the concentration of manganese in a container is less than 3.00% by weight, less than 2.50% by weight, less than 2.00% by weight, less than 1.80% by weight, less than 1.50% by weight or less than 1.00% by weight. In some embodiments, the concentration of magnesium in a container may be less than 7.00% by weight, less than 6.50% by weight, less than 6.00% by weight, less than 5.50% by weight, less than 5.00% by weight, less than 4.00% by weight, less than 3.00% by weight, or less than 2.00% by weight. In some cases, the container may be less than 1.00% by weight, less than 0.50% by weight, less than 0.20% by weight, less than 0.15% by weight, or less than 0.10% by weight of chromium, iron, silicon or copper.

The container may be generally cylindrical in shape and include one or more walls. For example, in some embodiments, the container includes one or more walls having a thickness of 0.090 mm to 0.150 mm. in some embodiments, the thickness of a wall of the container is at least 0.090 mm. In some embodiments, the thickness of a wall of the container may be at most 0.150 mm. In some embodiments, the thickness of a wall of the container may be 0.090 mm to 0.095 mm, 0.090 mm to 0.097 mm, 0.090 mm to 0.100 mm, 0.090 mm to 0.120 mm, 0.090 mm to 0.150 mm, 0.095 mm to 0.097 mm, 0.095 mm to 0.100 mm, 0.095 mm to 0.120 mm, 0.095 mm to 0.150 mm, 0.097 mm to 0.100 mm, 0.097 mm to 0.120 mm, 0.097 mm to 0.150 mm, 0.100 mm to 0.120 mm, 0.100 mm to 0.150 mm, or 0.120 mm to 0.150 mm.

In some embodiments, ingredients of the beverage may be mixed and then placed within a container using a cold-fill process. The chilled water may be at a temperature of between 34° F. and 50° F. For example, the chilled water may be between 38° F. and 42° F. The cooled beverage may then be carbonated, placed within a cold container, and then sealed within the container.

In some embodiments, the sealed container is capable of withstanding an internal pressure of no more than 120 psi. In some embodiments, the sealed container may be capable of withstanding an internal pressure of no more than 80 psi, no more than 85 psi, no more than 90 psi, no more than 95 psi, no more than 100 psi, no more than 105 psi, no more than 110 psi, no more than 115 psi, or no more than 120 psi.

In some embodiments, the contents within the sealed container may be pasteurized. Stated differently, in some embodiments, the beverage is pasteurized while disposed within the sealed container. In some embodiments, pasteurization of the beverage involves raising the temperature of the sealed container until a chosen pasteurization temperature is reached. In some embodiments, the temperature is gradually raised over a suitable period of time. For example, in some embodiments, the temperature is increased over a time period of 5 to 30 minutes. For instance, the gradual increase in the temperature may be performed over a period of from 5 minutes to 30 minutes. In some cases, the gradual increase in the temperature may be performed over a period of at least 5 minutes. In some cases, the gradual increase in the temperature may be performed over a period of at most 30 minutes. For instance, the gradual increase in the temperature may be performed from 5 minutes to 7 minutes, 5 minutes to 10 minutes, 5 minutes to 12 minutes, 5 minutes to 15 minutes, 5 minutes to 17 minutes, 5 minutes to 20 minutes, 5 minutes to 22 minutes, 5 minutes to 25 minutes, 5 minutes to 27 minutes, 5 minutes to 30 minutes, 7 minutes to 10 minutes, 7 minutes to 12 minutes, 7 minutes to 15 minutes, 7 minutes to 17 minutes, 7 minutes to 20 minutes, 7 minutes to 22 minutes, 7 minutes to 25 minutes, 7 minutes to 27 minutes, 7 minutes to 30 minutes, 10 minutes to 12 minutes, 10 minutes to 15 minutes, 10 minutes to 17 minutes, 10 minutes to 20 minutes, 10 minutes to 22 minutes, 10 minutes to 25 minutes, 10 minutes to 27 minutes, 10 minutes to 30 minutes, 12 minutes to 15 minutes, 12 minutes to 17 minutes, 12 minutes to 20 minutes, 12 minutes to 22 minutes, 12 minutes to 25 minutes, 12 minutes to 27 minutes, 12 minutes to 30 minutes, 15 minutes to 17 minutes, 15 minutes to 20 minutes, 15 minutes to 22 minutes, 15 minutes to 25 minutes, 15 minutes to 27 minutes, 15 minutes to 30 minutes, 17 minutes to 20 minutes, 17 minutes to 22 minutes, 17 minutes to 25 minutes, 17 minutes to 27 minutes, 17 minutes to 30 minutes, 20 minutes to 22 minutes, 20 minutes to 25 minutes, 20 minutes to 27 minutes, 20 minutes to 30 minutes, 22 minutes to 25 minutes, 22 minutes to 27 minutes, 22 minutes to 30 minutes, 25 minutes to 27 minutes, 25 minutes to 30 minutes, or 27 minutes to 30 minutes. For instance, the gradual increase in the temperature may be performed over a time period of approximately 5 minutes, 7 minutes, 10 minutes, 12 minutes, 15 minutes, 17 minutes, 20 minutes, 22 minutes, 25 minutes, 27 minutes, or 30 minutes. In some embodiments, the pasteurization process may further involve maintaining an elevated temperature (e.g., the highest chosen temperature) for a particular amount of time. The method may further comprise gradually cooling down the sealed container containing the beverage. In some instances, the container is gradually cooled down to a temperature of at least below 70° F., at least below 80° F., at least below 90° F. or at least below 100° F. before further processing. In some embodiments, a low-calorie sweetener, such as mogroside V, is not substantially degraded during the pasteurization process.

In some embodiments, pasteurization of beverages comprises heating the composition within the container to a temperature of between 130° F. and 180° F. In some embodiments, pasteurization of a beverage may comprise heating the composition within the container to a temperature of at least at least 130° F. In some embodiments, pasteurization of the beverage may comprise heating the composition within the container to a temperature of at most 180° F. In some embodiments, pasteurization of a beverage comprises heating the beverage within the container to a temperature of between 130° F. to 135° F., 130° F. to 140° F., 130° F. to 145° F., 130° F. to 150° F., 130° F. to 155° F., 130° F. to 160° F., 130° F. to 165° F., 130° F. to 170° F., 130° F. to 175° F., 130° F. to 180° F., 135° F. to 140° F., 135° F. to 145° F., 135° F. to 150° F., 135° F. to 155° F., 135° F. to 160° F., 135° F. to 165° F., 135° F. to 170° F., 135° F. to 175° F., 135° F. to 180° F., 140° F. to 145° F., 140° F. to 150° F., 140° F. to 155° F., 140° F. to 160° F., 140° F. to 165° F., 140° F. to 170° F., 140° F. to 175° F., 140° F. to 180° F., 145° F. to 150° F., 145° F. to 155° F., 145° F. to 160° F., 145° F. to 165° F., 145° F. to 170° F., 145° F. to 175° F., 145° F. to 180° F., 150° F. to 155° F., 150° F. to 160° F., 150° F. to 165° F., 150° F. to 170° F., 150° F. to 175° F., 150° F. to 180° F., 155° F. to 160° F., 155° F. to 165° F., 155° F. to 170° F., 155° F. to 175° F., 155° F. to 180° F., 160° F. to 165° F., 160° F. to 170° F., 160° F. to 175° F., 160° F. to 180° F., 165° F. to 170° F., 165° F. to 175° F., 165° F. to 180° F., 170° F. to 175° F., 170° F. to 180° F., or 175° F. to 180° F. In some embodiments, pasteurization of the beverages may comprise heating the composition within the container to a temperature of at least 130° F., 135° F., 140° F., 145° F., 150° F., 155° F., 160° F., 165° F., 170° F., 175° F., or 180° F.

Holding the beverage at a constant elevated temperature (e.g., the highest chosen temperature) may be performed for any suitable time, such as for 1 minute to 15 minutes. In some embodiments, the beverage is held at the elevated temperature for at least 1 minute. In some embodiments, the beverage is held at the elevated temperature for at most 15 minutes. In some embodiments, the beverage is held at the elevated temperature for 1 minute to 2 minutes, 1 minute to 5 minutes, 1 minute to 7 minutes, 1 minute to 10 minutes, 1 minute to 12 minutes, 1 minute to 15 minutes, 2 minutes to 5 minutes, 2 minutes to 7 minutes, 2 minutes to 10 minutes, 2 minutes to 12 minutes, 2 minutes to 15 minutes, 5 minutes to 7 minutes, 5 minutes to 10 minutes, 5 minutes to 12 minutes, 5 minutes to 15 minutes, 7 minutes to 10 minutes, 7 minutes to 12 minutes, 7 minutes to 15 minutes, 10 minutes to 12 minutes, 10 minutes to 15 minutes, or 12 minutes to 15 minutes. In some embodiments, the beverage is held at the elevated temperature for about 1 minute, about 2 minutes, about 5 minutes, about 7 minutes, about 10 minutes, about 12 minutes, or about 15 minutes.

In some embodiments, an uncarbonated beverage may be pasteurized prior to carbonation and aseptic filling of the container. For instance, in some embodiments, a beverage may be mixed to include water, monk fruit product, and a caloric sweetener. The beverage may then be pasteurized by heating, such as described above. The pasteurized beverage may then be carbonated via an aseptic process, and then inserted into an aseptic beverage container.

The beverages disclosed herein may be substantially devoid of colony forming units (cfu) of microorganisms after pasteurization (or other similar processing) and/or delivery into a sealed container. Microorganisms may include bacteria, yeast, mold, fungus. The number of cfus in the beverage following pasteurization and/or similar processing may be between 5 cfu/ml to 4 cfu/ml, 5 cfu/ml to 3 cfu/ml, 5 cfu/ml to 2 cfu/ml, 5 cfu/ml to 1 cfu/ml, 4 cfu/ml to 3 cfu/ml, 4 cfu/ml to 2 cfu/ml, 4 cfu/ml to 1 cfu/ml, 3 cfu/ml to 2 cfu/ml, 3 cfu/ml to 1 cfu/ml, or 2 cfu/ml to 1 cfu/ml. The number of cfus in the beverage following pasteurization and/or similar processing may be less than 5 cfu/ml, less than 4 cfu/ml, less than 3 cfu/ml, less than 2 cfu/ml, or less than 1 cfu/ml. In some embodiments, pasteurization and/or similar processing decreases the number of colony-forming units by at least 10-fold, at least 100-fold, at least 500-fold, or at least 10,000-fold.

### EXAMPLES

### Example 1

Carbonated Beverage. A carbonated beverage was produced and placed within traditional 12 fluid ounce aluminum cans as described below. The carbonated beverage comprised water, monk fruit juice concentrate and/or monk fruit extract, honey, citric acid, natural coloring, and natural flavoring (including blood orange). The carbonated beverage was produced by mixing the ingredients together in a mixing vessel. The mixture was homogenized at a low temperature (as low as 35° F. to 45° F.). The cooled mixture was then carbonated using a carbonator at preferred low temperatures (35° F. to 45° F.). Other analogous carbonating instruments and/or methods may alternatively be used. After carbonation, the beverage was placed into sealable aluminum cans. The cans were then sealed and pasteurized. The temperature for pasteurization was gradually increased for about 15 to 20 minutes until it reached the highest point of 140° F.-160° F. The high temperature of 140° F.-160° F. was maintained for about 5-10 minutes. The can was then cooled down slowly to a temperature of below 100° F. (The pasteurization temperature and heating/colling temperature profiles may vary depending on the pH of the beverage and/or the acid used.) After this cooling, the cans were prepared for packaging and shipping.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A beverage comprising:
carbonated water;
a monk fruit product; and
a caloric sweetener that is not from the monk fruit product;
wherein the beverage has between 15 and 35 calories per 12 fluid ounces.

2. The beverage of claim 1, further comprising citric acid.

3. The beverage of claim 1, further comprising one or more natural flavors.

4. The beverage of claim 1, further comprising a color additive.

5. The beverage of claim 1, wherein the monk fruit product comprises one or both of monk fruit juice concentrate or monk fruit extract.

6. The beverage of claim 1, wherein the beverage is substantially devoid of all of the following preservatives: sodium benzoate, potassium benzoate, calcium benzoate, erythorbic acid, calcium erythorbate, sodium erythorbate, butylated hydroxyanisole, butylated hydroxytoluene, phosphoric acid, sodium sorbate, potassium sorbate, sodium polyphosphate, potassium polyphosphate, sodium hexametaphosphate, tetrasodium pyrophosphate, propyl-p-hydroxy-benzoate, and methyl-p-hydroxy-benzoate (methylparaben), and EDTA.

7. The beverage of claim 1, wherein the beverage is a pasteurized beverage.

8. The beverage of claim 1, wherein the beverage has a pH of between 2.2 and 5.0.

9. The beverage of claim 1, wherein the beverage is substantially devoid of any artificial sweetener.

10. The beverage of claim 1, wherein the beverage is substantially devoid of all of the following sweeteners: acesulfame potassium, advantame, alitame, aspartame, cyclamate, dulcin, glucin, neohesperidin dihydrochalcone, neotame, P-4000, saccharin, aspartame-acesulfame salt, sucralose, brazzein, curculin, glycyrrhizin, glycerol, inulin, mabinlin, malto-oligosaccharide, mannitol, erythritol, xylitol, sorbitol, malitol, isomalt, lactitol, hydrogenated starch hydrolysates, miraculin, monatin, monellin, osladin, pentadin, stevia, trilobatin, and thaumatin.

11. The beverage of claim 1, wherein the caloric sweetener is present in the beverage at a concentration of between 1 gram and 4 grams per 12 fluid ounces of beverage.

12. The beverage of claim 1, wherein the caloric sweetener comprises honey or sucrose.

13. The beverage of claim 1, wherein the beverage is substantially devoid of both artificial colors and artificial flavors.

14. The beverage of claim 1, wherein the caloric sweetener comprises sucrose or honey, wherein the sucrose or honey is present in the beverage at a concentration of between 1 and 3 grams of sucrose or honey per twelve fluid ounces of beverage.

15. The beverage of claim 1, wherein the beverage is between 0.02% and 0.07% mogroside V by weight.

16. The beverage of claim 1, wherein the beverage is, by weight:
between 94% and 99% carbonated water;
between 0.02% and 0.07% mogroside V; and
between 0.3% and 0.7% caloric sweetener that is not from the monk fruit product.

17. A sealed container containing the beverage of claim 1.

18. The sealed container of claim 17, wherein the container comprises aluminum and is capable of withstanding an internal pressure of no more than 120 psi.

19. The sealed container of claim 18, wherein at least 2.0 volumes of CO₂ are dissolved in the beverage.

20. A method for producing a sealed beverage product, the method comprising:
obtaining the sealed container of claim 17; and
pasteurizing the beverage while the beverage is within the sealed container.

21. The method of claim 20, wherein pasteurizing the beverage comprises heating the beverage within the container to a temperature of at least 145° F.
